(19) United States
(12) Patent Application Publication
(10) Pub. No.: US 2017/0279128 A1
(43) Pub. Date: Sep. 28, 2017

(54) BIPOLAR FUEL CELL PLATE

(71) Applicant: SANDVIK INTELLECTUAL PROPERTY AB, Sandviken (SE)

(72) Inventors: Anna IVERSEN, Storvik (SE); Anders HOEL, Gavle (SE)

(73) Assignee: SANDVIK INTELLECTUAL PROPERTY AB, Bandviken (SE)

(21) Appl. No.: 15/514,178

(22) PCT Filed: Sep. 24, 2015
(86) PCT No.: PCT/EP2015/071931

§ 371 Date: Mar. 24, 2017

(30) Foreign Application Priority Data
Sep. 26, 2014 (EP) 14186622.8

(51) Int. Cl. H01M 8/021; C22C 38/42; H01M 8/10; C22C 38/04; C22C 38/02; C22C 38/00; C22C 38/44; C22C 38/52

(52) U.S. Cl. CPC H01M 8/021; C22C 38/44; C22C 38/42; C22C 38/52; C22C 38/04; C22C 38/02; C22C 38/001; H01M 8/10

(57) ABSTRACT

A bipolar fuel cell plate made of a stainless steel including the following elements, in mass %:
Cr 11-14;
Ni; 7-11;
Mo 3-5;
Co 0-2;
Cu 0.5-4;
Ti 0.4-2.5;
Mn <5;
Si <1.5;
S <0.04;
Al 0.05-1.0;
N <0.05;
C <0.05; and
   a balance of Fe and unavoidable impurities.

### TECHNICAL FIELD

The present disclosure relates to a bipolar fuel cell plate of a stainless steel comprising the following elements, in mass %: Cr 11-14, Ni 7-11, Mo 3-5, Co 0-2, Cu 0.5-4, Ti 0.4-2.5, Mn <5, Si <1.5, S<0.04, Al 0.05-1, N <0.05, C <0.05, balance Fe and unavoidable impurities.

The disclosure also relates to a proton exchange membrane (PEM) fuel cell comprising a bipolar fuel cell plate according to the disclosure.

### BACKGROUND

Stainless steel has been suggested by prior art for use as bipolar fuel cell plates, and has been considered attractive because of its ability to be mass-produced, its formability, its corrosion resistance and the fact that a non-coated stainless steel can be recycled at moderate cost. One drawback for many grades of stainless steel has been their contact resistance, which increases during use of these grades as fuel cell plates due to build-up of an oxide layer on the surface of the fuel plate. Grades presenting improved contact resistance have, on the other hand, been regarded as too expensive due to the need of relatively high amounts of expensive alloying elements, such as Ni, added in order to improve the contact resistance.

EP 1 302 556 discloses a stainless steel sheet consisting of 12.0-18.0 mass % Cr, 4.0-10.0 mass % Ni, 0.20 mass % or less C, 1.0-5.0 mass % Si, 5 mass % or less Mn, optionally one or more selected from Cu of up to 3.5 mass %, Mo of up to 5 mass %, N of up to 0.15 mass % and balance Fe and inevitable impurities. The stainless steel is austenitic-martensitic and is, among several applications, suggested for use as a fuel cell separator plate, which are used to physically separate individual fuel cells in a stack.

U.S. Pat. No. 5,512,237, discloses a precipitation hardened martensitic stainless steel of high strength and high ductility, comprising, in mass %, 10-14 Cr, 7-11, Ni, 0.5-6 Mo, 0-9 Co, 0.5-4 Cu, 0.4-1.4 Ti, 0.05-0.6 Al, and carbon and nitrogen not exceeding 0.05, and remainder Fe. The material is primarily suggested for use in medical, dental and spring applications as well as for specific product forms of wire, bar, strip and tube.

JP 2012177157 discloses a stainless steel for a separator for use in a fuel cell, e.g. a solid polymer type fuel cell, having a low contact resistance even in high potential regions. Any conventional stainless steel can be used, for example ferritic, austenitic, martensitic or dual phase type, wherein the stainless steel's surface is exposed to conductive intermetallic Fe₂M Laves phases.

It is an aspect of the present disclosure to provide a bipolar fuel cell plate comprising stainless steel of a grade presenting acceptably good contact resistance and corrosion properties for the use as a bipolar fuel cell plate and has a composition that enables production thereof to competitive costs. The stainless steel should also have sufficient formability.

### BRIEF DESCRIPTION OF THE DRAWINGS

FIG. 1 is a diagram showing test results regarding resistivity for three different stainless steel grades that are compared.

FIG. 2 is a diagram showing ICR results for three different fuel cell tests for steel grade 1.

### DETAILED DESCRIPTION

The aspect mentioned above is achieved by the present disclosure which provides a bipolar fuel cell plate of a stainless steel comprising the following elements, in mass %:
Cr 11-14;
Ni 7-11;
Mo 3-5;
Co 0-2;
Cu 0.5-4;
Ti 0.4-2.5;
Mn <5;
Si <1.5;
S <0.04;
Al 0.05-1.0;
N <0.05;
C <0.05;
   balance Fe and unavoidable impurities. In the present disclosure, “mass %” and “%” are used interchangeably.

A bipolar fuel cell plate is a fuel cell stack component, which allows electricity to be conducted between adjacent fuel cell membrane electrode assemblies in a stack. Bipolar fuel cell plates are often designed to channel the flow of gases and heat to and from the fuel cell. The stainless steel as defined hereinabove or hereinafter will provide bipolar fuel cell plates that will be uncoated, thus meaning that said stainless steel will form an outer surface of the bipolar fuel cell plate subjected to corrosive media and will be of importance for the electrical resistance properties of the bipolar fuel cell plate. The stainless steel as defined hereinabove or hereinafter has good contact resistance resistivity (ICR) just above 20 mOhm·cm² which is close to the recommendations of DoE (US Department of Energy) and corrosion properties (corrosion<1 μA/cm² in accordance with DoE) for the use as a bipolar fuel cell plate and has a composition enabeling production thereof to competitive costs. The stainless steel, as defined hereinabove or hereinafter, has also sufficient formability (>40% elongation without rupture).

In order to fully understand the influence of composition on the properties of the stainless steel of the bipolar fuel cell plate of the disclosure, all elements comprised in the stainless steel as defined hereinabove or hereinafter are discussed individually below. All element contents are in mass percent (mass %).

Carbon (C) is a powerful element affecting the stainless steel in many ways. High carbon content will affect the deformation hardening in a way that the strength upon cold deformation will be high and thus reducing the ductility of the stainless steel. High carbon content is also disadvantageous from corrosion point of view as the risk of precipitation of chromium carbides increase with increasing carbon content. The carbon content should therefore be kept low, less than or equal to about 0.05 mass %, such as less than or equal to about 0.025 mass %.

Silicon (Si) is a ferrite-forming element and may also in higher contents reduce the hot working properties of the stainless steel. The content of Si should therefore be less than or equal to about 1.5 mass %, such as less than or equal to about 1.0 mass %. Si may be less than or equal to about 0.5 mass %, such as Si less than or equal to about 0.25 mass %.

Manganese (Mn) is an austenite-forming element and in a similar way as nickel makes the stainless steel less prone to a martensitic transformation at cold deformation. According to one embodiment, the range of manganese is from about 0 to about 5 mass %. According to another embodiment, the minimum content of manganese of the stainless steel according to the disclosure is about 0.2 mass %. As the stainless steel has to have a significant content of martensite for the precipitation hardening, the manganese content should be maximum about 5 mass %, such as maximum about 3 mass %,such as less than or equal to about 2.5 mass %. Manganese will together with sulfur form ductile non-metallic inclusions which, for example, are beneficial for the machining properties.

Sulfur (S) is an element which will form sulfides in the stainless steel. Sulfides may act as weak areas in the stainless steel from a corrosion resistance point of view. Further, high contents of sulfur may also be detrimental for the hot working properties. The content of S should therefore be less than about 0.04 mass %, or even less than about 0.005 mass %. The composition of the alloy according to the disclosure is so selected that the alloy comprises titanium sulphides. The titanium sulphides may be present in the stainless steel in the form of TiS or Ti₂S.

Chromium (Cr) is essential for the corrosion resistance and must in the stainless steel as defined hereinabove or hereinafter be added in a content of at least about 11 mass % in order to obtain the passive properties in chromium oxide on the surface and maintain corrosion resistance in service. Chromium is however also a strong ferrite former, which in higher contents will suppress the martensitic formation upon deformation. The content of chromium therefore has to be restricted to maximum about 14 mass %, such as maximum about 13 mass %.

Nickel (Ni) is added to the stainless steel as defined hereinabove or hereinafter to balance the ferrite forming elements in order to obtain an austenitic structure upon annealing. Nickel is also an important element to moderate the hardening from cold deformation and will also contribute to the precipitation hardening together with elements such as titanium and aluminum. The minimum content of nickel is therefore about 7 mass %, such as at least about 8 mass %. A too high content of nickel will restrict the possibility to form martensitic upon deformation. Additionally, nickel is also an expensive alloying element. The content of nickel is therefore maximized to about 11 mass %.

Molybdenum (Mo) is essential for the stainless steel as defined hereinabove or hereinafter, as it will contribute to the corrosion resistance of the stainless steel. Molybdenum is also an active element during the precipitation hardening. The minimum content is therefore about 3 mass %. A too high content of molybdenum will however promote the formation of ferrite to a content that may result in problems during hot working and may also suppress the martensitic formation during cold deformation. Furthermore, a too high content of molybdenum will also have a negative impact on the contact resistance of a fuel cell plate made of the stainless steel as define hereinabove or hereinafter. The content of molybdenum is therefore maximized to about 5 mass %, such as to about 4.2 mass %.

Wolfram (W) is an optional element which may be added to the present stainless steel. It is possible to exchange Molybdenum (Mo) by Wolfram with respect corrosion resistance. If W is replacing Mo, the amount should be 3-5 mass %. The content of W is therefore maximized to about 5 mass %, such as to about 4.2 mass %.

Copper (Cu) is an austenite former and will together with nickel stabilize the desired austenitic structure. Copper is also an element which increases the ductility in moderate contents. Copper may have a positive effect on the contact resistance of fuel cell plates made of the stainless steel of the present disclosure. The minimum content is therefore more than or equal to about 0.5 mass %. However, on the other hand copper in high contents reduces the hot workability why the copper content is maximized to about 4 mass %, such as maximum about 3 mass %, such as maximum about 2 mass %.

Titanium (Ti) is an essential alloying element in the disclosure due to many reasons. Nb is equivalent to Ti in respect of carbide formation, intergranular corrosion and stabilisation of the formed Cr-oxide. Firstly, titanium is used as a strong element for precipitation hardening and must therefore be present in the stainless steel in order to be able to harden the stainless steel for the final strength. Secondly, titanium will together with sulfur form titanium sulfides (TiS or possibly Ti₂S). In general, titanium is a stronger sulfide former than manganese and as TiS are electrochemically nobler that MnS, it is possible to achieve improved machining properties without deterioration of the corrosion resistance which is the normal case for free machining stainless steels utilizing MnS for the increased machinability. Therefore, the minimum content of titanium is about 0.4 mass %, such as about 0.5 mass %. However, too high titanium contents will promote ferrite formation in the stainless steel and also increase the brittleness as well as decreased formability property. The maximum content of titanium should therefore be restricted to about 2.5 mass %, such as about 2 mass %, such as not more than about 1.5 mass %. It is reasonable to assume that there is a risk of having transpassive corrosion or intergranular corrosion at an operation potential of a fuel cell of 0.7 V/Ag,AgCl (0.9 V/SHE). Ti should be present in the material in order to prevent chromium carbide precipitations, in particular at higher carbon contents (approaching the upper limit of 0.05 mass %) at an operation potential of a fuel cell of 0.7 V/Ag,AgCl (0.9 V/SHE). Chromium carbide precipitations may result in intergranular corrosion. According to an embodiment, the content of Ti (expressed in mass %) is such that Ti≧6×C, i.s, the mass % content of Ti is at least six times higher than the mass % content of C.

Niobium (Nb) is an optional element which may be added to the present stainless steel. It is possible to exchange Titanium (Ti) by Niobium with respect of the stabilization against intergranular corrosion due to similar properties and mechanism in formation of carbides. If Nb is replacing Ti, the amount should be 0.4-2.5 mass %. The maximum content of Niobium should therefore be restricted to 2.5 mass %, such as about 2 mass %, such as not more than about 1.5 mass %.

Aluminum (Al) is added to the stainless steel as defined hereinabove or hereinafter in order to improve the hardening effect upon heat treatment. Aluminum is known to form intermetallic compounds together with nickel such as Ni₃Al and NiAl.

In order to achieve a good hardening response and good forming properties, the minimum content should be at least or equal to about 0.05%, such as at least or equal to about 0.3%. Aluminum is however a strong ferrite former why the maximum content should be not more than or equal to about 1 mass %. Hence, according to one embodiment, the content of Al is between 0.05 and 0.6 mass %.

Nitrogen (N) is a powerful element as it will increase the strain hardening. However, it will also stabilize the austenite towards martensitic transformation at cold forming. Nitrogen also has a high affinity to nitride formers such as titanium, aluminum and chromium. The nitrogen content may be restricted to maximum about 0.05 mass %.

Cobalt (Co) is an optional element which may enhance the tempering response, especially together with molybdenum. However, a disadvantage with cobalt is the price. It is also an element which is undesirable at stainless steel works. With respect to the cost and the stainless metallurgy it is therefore preferable to avoid alloying with cobalt. The content is therefore less than or equal to about 2 mass %, or even less than or equal to about 1 mass %, such as less than or equal to 0.6 mass %.

The stainless steel as defined hereinabove or herein after may optionally comprise one or more of the following elements V, Zr, Hf, Ta, Mg, Ca, La, Ce, Y and B in the amounts of maximum 0.1 wt %. These elements may be added in order to improve certain processablility properties such as e.g. machinability.

The term “impurities” as referred to herein is intended to mean substances that will contaminate the stainless steel when it is industrially produced, due to the raw materials such as ores and scraps, and due to various other factors in the production process, and are allowed to contaminate within the ranges not adversely affecting the austenitic stainless steel as defined hereinabove or hereinafter.

According to one embodiment, the contents of Mo and Cr are such that 24≦mass % Cr+mass % Mo×4≦32. By choosing a suitable absolute amounts of Cr and Mo and also by balancing the relative amounts of Cr and Mo, low contact resistance as well as corrosion resistance is obtained for the bipolar fuel cell plates manufactured of the stainless steel as defined hereinabove or hereinafter. However, the total amount of both molybdenum and chromium is not allowed to be at minimum content in % and the total amount of both molybdenum and chromium is not allowed to be at maximum content in %.

According to another embodiment of the present disclosure, the sum of Cr and Mo may be 26≦mass % Cr+mass % Mo×4, such as 27≦mass % Cr+mass % Mo×4. Thereby, further improved corrosion resistance of a bipolar fuel cell plate made of the stainless steel of the present disclosure is achieved.

According to yet another embodiment, the sum of Cr and Mo may be such that mass % Cr+mass % Mo×4≦30, such that mass % Cr+mass % Mo×4≦29. Thereby, possible formation of oxides on the surface of the bipolar fuel cell plate made of the stainless steel of the disclosure is further suppressed, and contact resistance of the plate is lower.

The stainless steel as defined hereinabove or hereinafter has an austenitic structure. The relatively high content of Ni in the stainless steel of the present disclosure makes the stainless steel less prone to hydrogen embrittlement and corrosion related thereto. This is particularly important on the anode side of a bipolar fuel cell plate, where hydrogen gas passes. A martensitic structure, on the other hand, is much more prone to such corrosion related to hydrogen embrittlement.

The disclosure also relates to a proton exchange membrane fuel cell, wherein in that it comprises a bipolar fuel cell plate as defined hereinabove and/or hereinafter.

The bipolar fuel cell plate may be produced by, for example, using continuous casting of the stainless steel, followed by hot rolling of the cast, annealing and pickling, further cold rolling steps with intermediate recrystallization annealing steps, and cutting and forming to the intended shape of the bipolar fuel cell plate.

The present disclosure is further illustrated by the following non-limiting experiments and examples.

### Examples

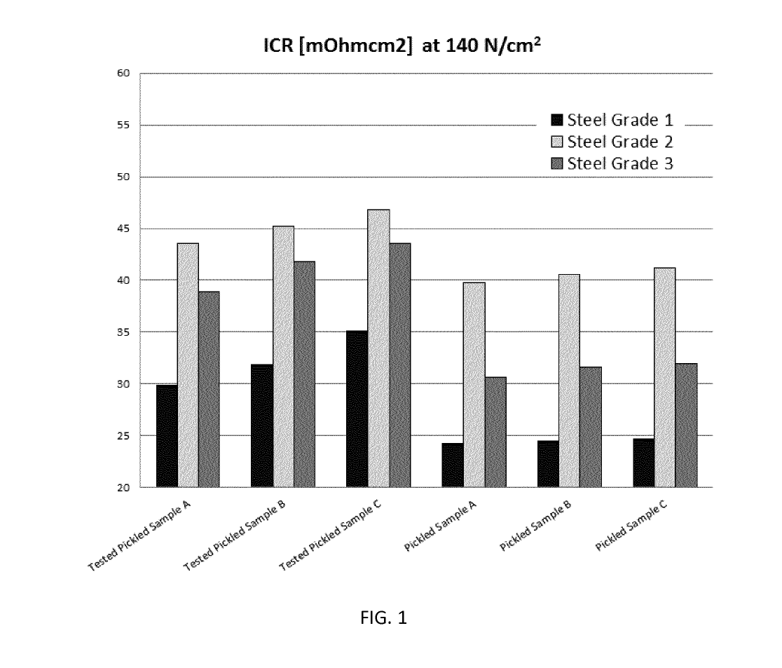

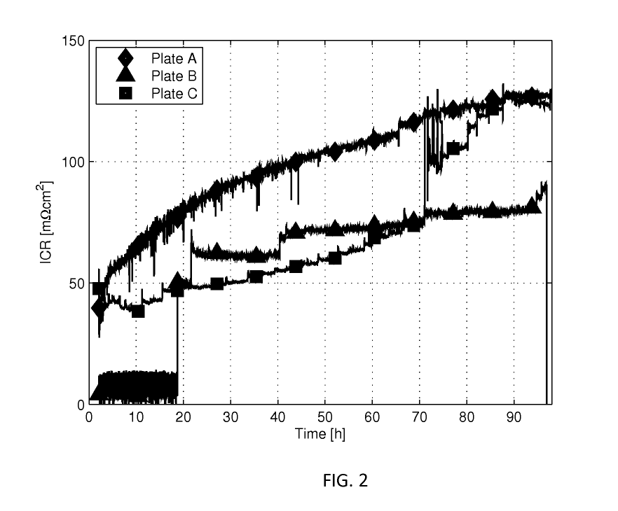

The experimental results are presented with reference to FIGS. 1 and 2.

Previous results from earlier tests have shown that the addition of molybdenum to stainless steel used as a bipolar fuel cell plate will contribute to a more resistive passive film on a bipolar fuel cell plate and that a high chromium content combined with the molybdenum content is the reason for an unacceptable increase in the resistivity (contact resistance) of the passive film. Experiments have now been performed showing that an acceptable contact resistance is obtained provided that the chromium content is below a predetermined level in stainless steel containing the further alloying elements as defined by the present disclosure. However, molybdenum is of importance since the corrosion resistance is greatly improved by this alloy element. A proper balancing of the chromium and molybdenum levels of a stainless steel according the disclosure is therefore of utmost importance to achieve both an acceptable contact resistance and corrosion resistance of a bipolar fuel cell plate made thereof.

In the following, test data obtained from a comparison of three different stainless steels is presented, wherein steel grade 1 is stainless steel according to the present disclosure. Steel grade 2 is a stainless steel which, with regard to the alloying elements that primarily are deemed as crucial to the functionality of the material as a bipolar fuel cell plate, falls within the limits of the in the background mentioned document EP 1 302 556 and has a rather low content of Mo combined with a rather high content of Cr. Steel grade 3 is a comparative stainless steel sample which is characterised by a significantly higher content of Ni and a high content of Cr, and which is an example of a stainless steel, which has acceptable corrosion and contact resistance properties for use as a bipolar fuel cell plate, but is costly due to its high content of alloying elements Cr and Ni (see table 1).

### Resistivity

A long term potentiostatic testing method was applied in order to find out the long term behaviour of the respective stainless steel under simulated fuel cell conditions. Potentiostatic testing is regarded as the common method of simulation of the operation of a PEM fuel cell and is well known to the person skilled in the art. The potential was set to 0.7 V/Ag,AgCl for 1000 hours instead of 100 hours, 100 hours has previously been considered as a long time test. The procedure is referred to as passivation of the samples due to the hypotheses that the potentiostatic load enhances the passive film. The aim of this testing was to find out whether the contact resistance and the passive film revealed lowering, maintaining or unacceptable increase in the contact resistance under these circumstances.

The electrolyte simulating the cathode side of a PEM fuel cell was prepared for 5 L containing: 436 g K₂SO₄ (0.5 M) (pro analysis), 0.0015 g KF (pro analysis). The pH was adjusted to pH=3 using sulphuric acid (H₂SO₄) by adding 2.554 g of 96% H₂SO₄.

Interfacial contact resistance was measured. The interfacial contact resistance, ICR setup consisted of a hydraulic piston applying a pressure from 0 to 20 bars or 0-200 N/cm². Two gold plated holders with a contact radius of 1.5 cm or contact area of 12.56 cm² were used. The sample was arranged in a two gas diffusion layer, i.e. GDL which was located between the two gold plated contact holders. A constant current supply of 12.56 A constant current supply was applied which resulted in a current density of 1 A/cm².

Contact resistance measurements were carried out before and after tests in simulated PEM fuel cell electrolyte.

The result of the contact resistance measurements is shown in FIG. 1. The figure shows sequential measurements, A, B, C on the same sample. Three measurements A, B, C have been performed by letting an electric current pass through a plate of the respective stainless steel grade, wherein the current is 1 A/cm². This is performed on a sample that has been subjected to the potentiostatic testing (tested pickled sample), and compared to a pickled sample not previously subjected to potentiostatic testing (named “pickled sample” in FIG. 1). As can be seen in FIG. 1, in both cases the performance of stainless steel grade 1 according to the disclosure is superior to the performance of comparison stainless steel grades 2 and 3.

### Corrosion

Corrosion tests were performed on stainless steel grade 1 according to the disclosure at 80° C. in simulated fuel cell electrolyte: 5 L containing 436 g K₂SO₄ (0.5 M) (pro analysis), 0.0015 g KF (pro analysis). The pH was adjusted to pH=3 using sulphuric acid (H₂SO₄) by adding 2.554 g of 96% H₂SO₄. The simulation of PEM bipolar fuel cell behaviour was represented by current passing the plate resulting in a potential similar to the potential of the PEM bipolar fuel cell in operation or an applied oxidative potential.

No corrosion was observed on the sample surfaces after test.

Calculation of mass loss rates by converting corrosion current densities was carried out using Faradays law and assuming linear relationship between the corrosion current and the metal dissolution rates. The calculations were performed for both alloys using the equivalent weight as described in the standard ASTM G 102-89.

Ew=(Σnᵢfᵢ/Mᵢ)⁻¹
nᵢ=valence of alloy element i
fᵢ=mass fraction of the element i in the alloy
Mᵢ=atomic weight of element i in the alloy

The corrosion rate for a pure metal may be calculated according to:

Corrosion rate=(K×M×i_{corr})/(n×ρ)[mm/year]

The same equation for a metal alloy using the equivalent weight Ew:

Corrosion rate=K×Ew×i_{corr}/ρ[mm/year]
M=atomic weight
n=valence of the element
i_{corr}=corrosion current density, μA/cm²
ρ=density of the material, g/cm³
K=(mm g/μA cm y)

Calculations of the corrosion rate were carried out using the equivalent weight as described in the standard ASTM G 102-89.

Ew=(Σnᵢfᵢ/Mᵢ)⁻¹
nᵢ=valence of alloy element i
fᵢ=mass fraction of the element i in the alloy
Mᵢ=atomic weight of element i in the alloy

The average current density was calculated to 1.51×10⁻⁹ A/cm² which sets a calculated corrosion rate of 1.2×10⁻⁵ mm/y, which is a negligible corrosion rate.

As can be seen from above the suggested stainless steel to be used as a bipolar fuel cell plate, in particular a PEM bipolar fuel cell plate, presents properties that makes it more suitable for said application than prior art stainless steel. Moreover, the stainless steel according to the disclosure obtains these results with a surprisingly low total content of alloying elements and thereby at a very competitive price.

### Fuel Cell Test

The bipolar plates were cleaned using ultrasonic cleaning in ethanol and deionized water during 15 min respectively. The fuel cell setup was heated in a flow of nitrogen gas. At the operation temperature (80° C.), the gas was changed to hydrogen gas and oxygen gas. The material in the fuel cell components except the bipolar plate were commercial platinum, Pt cathode and platinumruthenium, Pt anode. The Gas diffusion Layer, GDL was of Sigracet 25BC. An activation sequence was carried out by polarization between 0.9-0.3-0.9V, and a scan rate of 5 mV/s in 50 mV steps. The fuel cell was run at a constant current 0.5 A/cm2 for 96 hours and a measurement point per 10 sec over the bipolar plate.

In FIG. 2 the interfacial contact resistance is seen to increase as a consequence of the equilization of the operation conditions of the fuel cell. The plates A, B and C constitutes of different plates of composition in Steel Grade 1.

Steel Grade 1 is a composition according to the present disclosure. Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

TABLE 1
Element Analysis of the materials used in the investigation (in mass %).

| Steel | | | | | | | | |
|---|---|---|---|---|---|---|---|---|
| Grade | C | Si | Mn | Cu | Co | Cr | Mo | N |
| 1 | 0.008 | 0.17 | 0.41 | 1.99 | 0.041 | 11.70 | 3.85 | 0.004 |
| 2 | 0.09 | 1.21 | 1.17 | 0.029 | 0.027 | 16.4 | 0.28 | 0.029 |
| 3 | 0.016 | 0.41 | 1.54 | 1.36 | 0.096 | 19.77 | 4.15 | 0.047 |
| | Ti | Ni | Al | Fe | | | | |
| 1 | 1.00 | 8.90 | 0.39 | Bal | | | | |
| 2 | — | 6.7 | — | Bal | | | | |
| 3 | 0.003 | 24.53 | 0.037 | Bal | | | | |

1. A bipolar fuel cell plate of a stainless steel comprising in mass %:
Cr 11-14;
Ni 7-11;
Mo 3-5;
Co 0-2;
Cu 0.5-4;
Ti 0.4-2.5;
Mn <5;
Si <1.5;
S <0.04;
Al 0.05-1.0;
N <0.05;
C <0.05; and
a balance of Fe and unavoidable impurities.

2. The bipolar fuel cell plate according to claim 1, wherein 24≦mass % Cr+mass % Mo×4≦32.

3. The bipolar fuel cell plate according to claim 2, wherein 26≦mass % Cr+mass % Mo×4.

4. The bipolar fuel cell plate according to claim 2, wherein mass % Cr+mass % Mo×4≦30.

5. The bipolar fuel cell plate according to claim 1, wherein mass % Mo is of from 3 to 4.2.

6. The bipolar fuel cell plate according to claim 1, wherein mass % Cr is of from 11 to 13.

7. The bipolar fuel cell plate according to claim 1, wherein mass % Cu is of from 0.5 to 2.

8. The A bipolar fuel cell plate according to claim 1, wherein mass % Si≧0.5.

9. The bipolar fuel cell plate according to claim 1, wherein mass % Si≦0.25.

10. The bipolar fuel cell plate according to claim 1, wherein mass % Al is between 0.05 and 0.6.

11. The bipolar fuel cell plate according to claim 1, wherein mass % Co≦0.6.

12. The bipolar fuel cell plate according to claim 1, wherein mass % Ni is of from 8 to 11.

13. The bipolar fuel cell plate according to claim 1, wherein mass % Ti≧6×mass % C.

14. A proton exchange membrane fuel cell, wherein the proton exchange membrane fuel cell comprises a bipolar fuel cell plate according to claim 1.
